(19) United States
(12) Patent Application Publication
(10) Pub. No.: US 2014/0259140 A1
(43) Pub. Date: Sep. 11, 2014

(54) USING LEARNED FLOW REPUTATION AS A HEURISTIC TO CONTROL DEEP PACKET INSPECTION UNDER LOAD

(71) Applicant: Sakthikumar Subramanian, San Jose, CA (US)

(72) Inventor: Sakthikumar Subramanian, San Jose, CA (US)

(21) Appl. No.: 13/996,599

(22) PCT Filed: Mar. 11, 2013
(86) PCT No.: PCT/US2013/030229

§ 371 Date: Jun. 21, 2013

(51) Int. Cl. H04L 29/06

(52) U.S. Cl. CPC H04L 63/02; H04L 63/1408
USPC 726/11

(57) ABSTRACT

A network appliance can adjust the amount of deep packet inspection performed by the network appliance as a function of load. In one example, the network appliance can be configured to utilize load (e.g., of its internal processors) and reputation of data flows to determine when selected trusted flows can bypass inspection performed using deep packet analysis. Reputation of data flows can be determined based on historical information regarding a particular flow in combination with a reputation service determining reputation scores based on properties of the data flow (e.g., source, type of data in flow, destination, Internet Protocol domains, etc.). In general, when the network appliance is under heavy load, the more trusted flows are allowed to pass through without in depth inspection.

### TECHNICAL FIELD

This disclosure relates generally to a system and method for adjusting amount of deep packet inspection performed by a network appliance as a function of load. More particularly, but not by way of limitation, this disclosure describes a network appliance configured to utilize load and reputation of data flows to determine when selected “trusted” flows can bypass inspection performed using deep packet analysis.

### BACKGROUND

Deep Packet Inspection (DPI) is a form of computer network packet filtering that examines the data part (and possibly also the header) of a packet as it passes an inspection point. DPI is also sometimes referred to as complete packet inspection and/or Information eXtraction (IX) and can be performed at the inspection point along with other types of inspection or filtering. DPI searches for unwanted data inside of network messages or streams of data (e.g., streaming video, streaming audio, etc.). The unwanted data can be considered a virus, spam, intrusion, non-compliant package or other defined criteria. In some instances, the data is not necessarily unwanted but DPI can be used to collect and calculate metrics relative to users and the types of data being accessed via the network.

DPI can be configured to operate independently (e.g., a device configured to perform mainly this function) or can be combined with the functionality of an intrusion detection system (IDS), an intrusion prevention system (IPS), and/or other traditional firewall functions (e.g., shallow packet inspection, stateful firewall functions, etc.). The combination of functions is usually a design or configuration choice by a network administrator and a capability set provided by the manufacturer or the network appliance performing the desired functions. Alternatively, a plurality of network appliances can be configured to perform independent functions and share results to enable a more comprehensive system than could be provided by an individual network appliance operating in isolation.

DPI-enabled devices have the ability to look at Layer 2 and beyond Layer 3 of the OSI model. In some instances, DPI can be configured to look through layers 2-7 including headers, data protocol portions, and the actual payload of the message. DPI can identify and classify network traffic using a signature data base. The signature data base can be used for comparison of signatures generated from the payload of the message. If a packet fails the inspection parameters, the packet may be blocked, dropped, rate limited (along with other packets from the same source), reported to a reporting agent (e.g., software agent) or agency (e.g., human alert), marked or tagged for future actions, along with many other possible actions.

Because DPI capabilities and other network analysis functionality can overwhelm the capabilities of network devices (e.g., overload), care must be taken when configuring the amount of work (e.g., functionality) performed by the individual devices. Also, because the amount and type of network traffic changes over time based on activities that are not always predictable an administrator cannot predict exactly optimal configurations for network appliances performing the above mentioned functions. For example, an Internet broadcast of a popular sporting event will likely cause a substantial increase in the amount of streaming audio and video on the Internet. Similarly, an outbreak of war or a terrorist attack could cause many people to begin trying to gather information from the Internet from one or more news organizations. Because of these and other concerns, there is a need for systems and methods that dynamically adjust configuration and/or processing based on load so that a network appliance can react to changing conditions without unnecessarily impacting users dependent on that network appliance. The following disclosure addresses these and other issues.

### BRIEF DESCRIPTION OF THE DRAWINGS

FIG. 1 is a block diagram illustrating network architecture 100 according to one or more disclosed embodiments.

FIG. 2 is a block diagram illustrating a computer with a processing unit which could be configured to act as a processor in a network appliance, firewall, gateway, etc. according to one or more disclosed embodiments.

FIG. 3 is a network architecture showing a set of reputation servers configured into a support infrastructure which could be used to enhance the functionality of independent network appliances according to one or more disclosed embodiments.

FIG. 4A is a network diagram disclosing possible network service providers and potential end users supported by a network appliance (430) configured according to one or more disclosed embodiments.

FIG. 4B illustrates a relationship of trust and load for variable analysis which could be performed by the network appliance (430) of FIG. 4B.

FIGS. 5-7 illustrate flowcharts of an example process for automatically adjusting functions performed by a network appliance according to load using factors determined from flow analysis (e.g., DPI) and possibly other external factors (e.g., reputation) according to one or more disclosed embodiments.

### DESCRIPTION OF DISCLOSED EMBODIMENTS

Deep packet inspection such as that performed by a Intrusion Prevention System (IPS) can be a computationally demanding activity. The amount of compute cycles needed by an IPS to perform analysis at any time can depend on the content being inspected at that time. For example, searching for attack patterns within 500 byte URLs is more compute intensive than inspecting URLs less than 100 bytes long. The traffic content inspected by an IPS can also vary based on changes to network traffic caused by external circumstances such as an internet broadcast of a popular sporting event, a company “all-hands” network broadcast, a regularly scheduled backup or even a denial-of-service attack.

Because the content processed by an IPS and required compute cycles vary from time to time, it could be beneficial for an IPS to utilize its compute cycles intelligently under load. When compute cycles are inadequate for thorough inspection of all packets, the IPS could be configured to invest the available compute cycles for examining “entrusted” flows (flows likely to be malicious or unanalyzed) while forwarding “trusted” flows without spending compute cycles to inspect the trusted flows. An algorithm balancing risk versus performance could be configured into the processor(s) of the IPS to make a determination as to which flows to allow through without further inspection. The algorithm could further dynamically adjust the risk versus performance based on increases in load on the processors (e.g., let more flows through without inspection) or decreases in load on the processors (e.g., resume analysis of flows previously considered trusted).

This disclosure describes, among other things, a heuristic to separate flows into trusted and entrusted flows. Flows that were previously not processed by the IPS can be initially classified as untrusted. A flow can attain a higher trust level if no attack is seen after an initial number of instances of the flow (e.g., 100 flow instances) have been analyzed by the IPS. The trust level of each individual flow can be tracked in a hash table or other means. When under load, the IPS can be configured to forward sets of flows based on a trust level without analysis (e.g., skip DPI) while continuing to inspect other less trusted flows. In this manner it could be possible for the IPS system to make more intelligent use of available compute cycles.

Example disclosed embodiments describe a heuristic to separate flows into trusted and untrusted flows (or flows assigned to a trust level range). A flow is usually described by the 5-tuple: <receiving IP address, receiving source port, sending IP address, sending port, protocol (tcp/udp)>. Because receiving source port is chosen randomly (e.g., by a client) for each flow, it does not usually provide any more information than the receiving IP address in determining the trustworthiness of a flow. In one embodiment, the 4-tuple: <receiving IP address, sending IP address, sending port, protocol (udp/tcp)> can be used to distinguish flows. For example, if an end device opened 10 connections to a web site using a browser, then all of the connections could be mapped to a common flow bucket as they share the same 4-tuple information. In the context of this disclosure a “flow” is a communication path between a sending computer (e.g., server) and a receiving computer (e.g., client). The communication path can include different types of connection protocols (e.g., broadcast or point to point) to provide the communication between the two computers and can be unidirectional or bidirectional.

The network appliance device can track the trust level of all flows seen by it in a hash table. The trust level can vary based upon, for example, whether or not attacks are ever detected on that flow. In one embodiment, the hash table can be an array of doubly-linked lists, where each list contains a set of flows whose 4-tuple hashes are equal. Flows in the table may be in one of 3 basic states: trusted, untrusted or in evaluation. Also, as explained further herein, trusted flows can have a variable trust level from least trusted to most trusted. The number of flow instances (referred to as flow count) processed per flow can also be stored. Flows that were previously not processed by the IPS can be initially classified as “in evaluation”. “In evaluation” flows can be marked untrusted with flow count >0. Untrusted flows can be identified by being categorized as untrusted with a flow count set to 0.

In a simple example, when a web connection is seen from a client to a server for the first time, it can be recorded in the hash table. The flow is initially marked untrusted with flow count set to 1 (e.g., in evaluation) provided the initial portion of the flow was non-malicious, i.e., no attacks were detected on the flow. As more non-malicious flow instances are seen over the same 4-tuple, the flow count can be incremented until an initial trust determination threshold (e.g., 100) is reached. Once the initial trust determination threshold is reached, the flow can be marked as trusted. In some embodiments, the network appliance can continue to track the flow count as a measure of trustworthiness of the flow. If at any time, an attack is detected on a flow, then the flow can be marked untrusted and the flow count can be set back to 0 to indicate that the flow was malicious.

Under load, the IPS can make a variable determination to forward flows of a determined trust level without inspection while continuing to inspect untrusted flows and other flows of a lower trust level thus making intelligent use of available compute cycles. The IPS can detect an overloaded condition by checking the size of its input queue or some other means (e.g., processor load utilization). All flows can be checked against the flow reputation hash table and the decision to forward or further inspect a flow can be based on whether or not the flow is marked with an appropriate trust level relative to a current load determination. This logic can remain in effect and dynamically adjust which flows are further inspected (or skipped) until the load reduces below a next previous threshold. At that point the network appliance can resume inspection of more flows even though they are currently at a relatively higher trust level. When processor load falls below the first load threshold the network appliance can resume inspection of all flows regardless of their associated trust level.

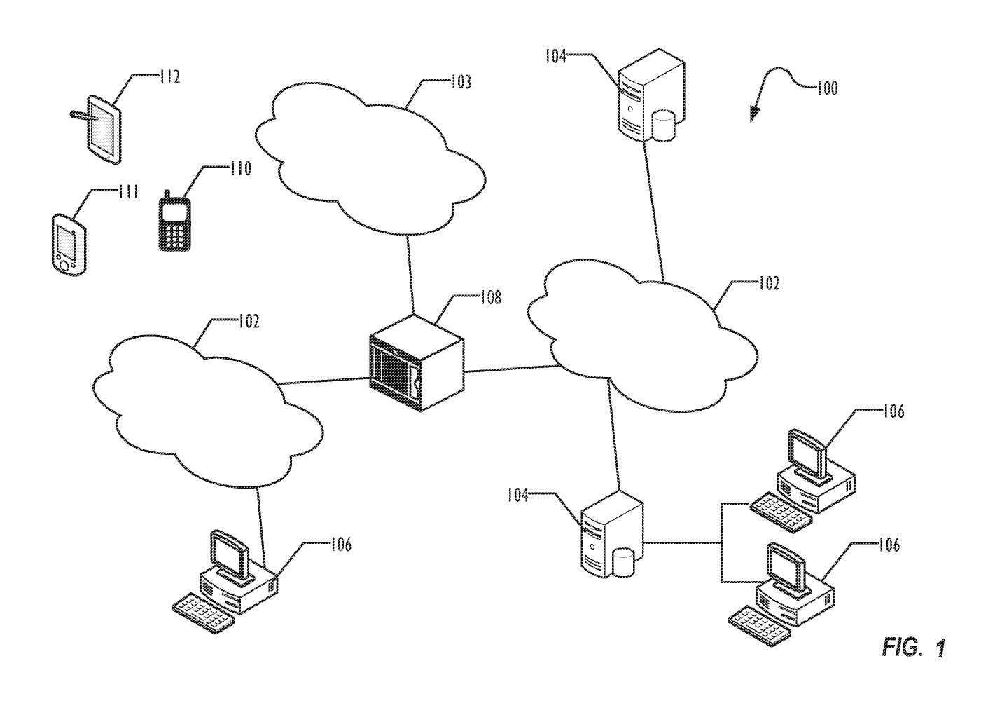

Referring now to FIG. 1, infrastructure 100 is shown schematically. Infrastructure 100 contains computer networks 102. Computer networks 102 include many different types of computer networks available today such as the Internet, a corporate network or a Local Area Network (LAN). Each of these networks can contain wired or wireless devices and operate using any number of network protocols (e.g., TCP/IP). Networks 102 are connected to network appliances such as gateways and routers (represented by 108), end user computers 106, and computer servers 104. Also shown in infrastructure 100 is cellular network 103 for use with cellular communication. As is known in the art, cellular networks support cell phones and many other types of devices (e.g., tablet computers 112, PDA 111 or a lap top computer (not shown)). Cellular devices in the infrastructure 100 are illustrated as cell phones 110. Obviously cell phones 110 can be smart phones or other devices of similar capabilities. Infrastructure 100 is illustrative and by way of example only and other infrastructures can be employed with the techniques described below.

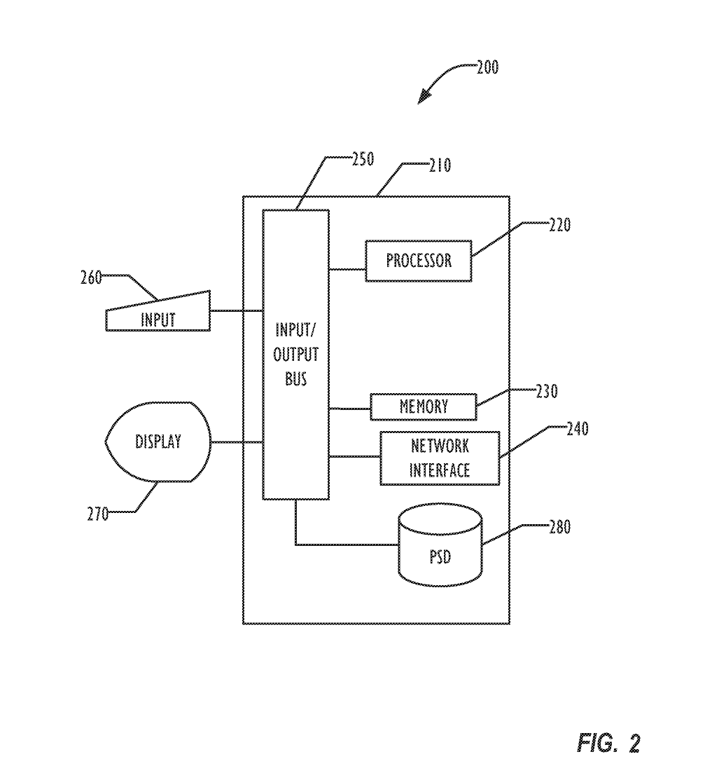

Referring now to FIG. 2, an example processing device 200 for use in providing disclosed DPI techniques according to one embodiment is illustrated in block diagram form. Processing device 200 may be implemented in various devices, such as a cellular phone 110, gateway or router 108, client computer 106, or a server computer 104. Example processing device 200 comprises a system unit 210 which may be optionally connected to an input device 260 (e.g., keyboard, mouse, touch screen, etc.) and display 270. A program storage device (PSD) 280 (sometimes referred to as a hard disc, flash memory, or computer readable medium) is included with the system unit 210. Also included with system unit 210 may be a network interface 240 for communication via a network (such as cellular network 103 or computer network 102) with other computing and corporate infrastructure devices (not shown) or other cellular communication devices. Network interface 240 may be included within system unit 210 or be external to system unit 210. In either case, system unit 210 is communicatively coupled to network interface 240. Program storage device 280 represents any form of non-volatile storage including, but not limited to, all forms of optical and magnetic memory, including solid-state, storage elements, including removable media, and may be included within system unit 210 or be external to system unit 210. Program storage device 280 may be used for storage of software to control system unit 210, data for use by the processing device 200, or both.

System unit 210 may be programmed to perform methods in accordance with this disclosure. System unit 210 comprises one or more processing units (represented by processor 220), input-output (I/O) bus 250, and memory 230. Memory 230 may be accessed using the communication bus 250. Processing unit 220 may include any programmable controller device including, for example, a mainframe processor, a cellular phone processor, or one or more members of the Intel ATOM®, CORE®, PENTIUM® and CELERON® processor families from Intel Corporation and the Cortex and ARM processor families from ARM. (INTEL, INTEL ATOM, CORE, PENTIUM, and CELERON are registered trademarks of the Intel Corporation. CORTEX is a registered trademark of the ARM Limited Corporation. ARM is a registered trademark of the ARM Limited Company). Memory 230 may include one or more memory modules and comprise random access memory (RAM), read only memory (ROM), programmable read only memory (PROM), programmable read-write memory, and solid-state memory. Processor 220 may also include some internal memory including, for example, cache memory or memory dedicated to a particular processing unit and isolated from other processing units.

Processing device 200 may have resident thereon any desired operating system. Embodiments of disclosed inspection techniques may be implemented using any desired programming language, and may be implemented as one or more executable programs, which may link to external libraries of executable routines that may be supplied by the provider of the inspection software/firmware, the provider of the operating system, or any other desired provider of suitable library routines. As used herein, the term “a computer system” can refer to a single computer or a plurality of computers working together to perform the function described as being performed on or by a computer system.

In preparation for performing disclosed embodiments on processing device 200, program instructions to configure processing device 200 to perform disclosed embodiments may be provided stored on any type of non-transitory computer-readable media, or may be downloaded from a server 104 onto program storage device 280. Even though a single processing device 200 is illustrated in FIG. 2, any number of processing devices 200 may be used in a device configured according to disclosed embodiments.

We now turn to a discussion of various embodiments to automatically adjust an IPS system based on analysis load to overcome some of the previously explained problems when load of a network appliance increased over certain thresholds. As will be explained below, a network appliance can adjust which flows are analyzed from analyzing all flows to analyzing no flows (if the load reaches an extreme threshold). When no flows can be analyzed the network appliance can be configured to block or drop packets associated with that flow based on desired security considerations. In some non-sensitive environments, the network appliance could even be configured to allow untrusted flows to pass through, but this decision could lead to security implications for end users supported by the network appliance.

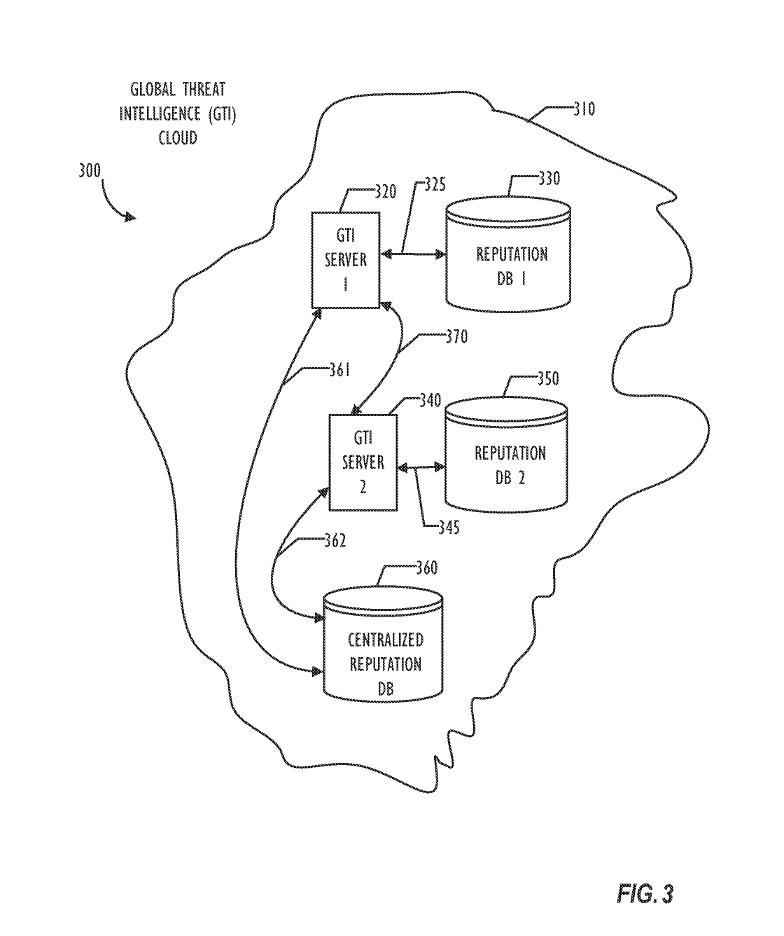

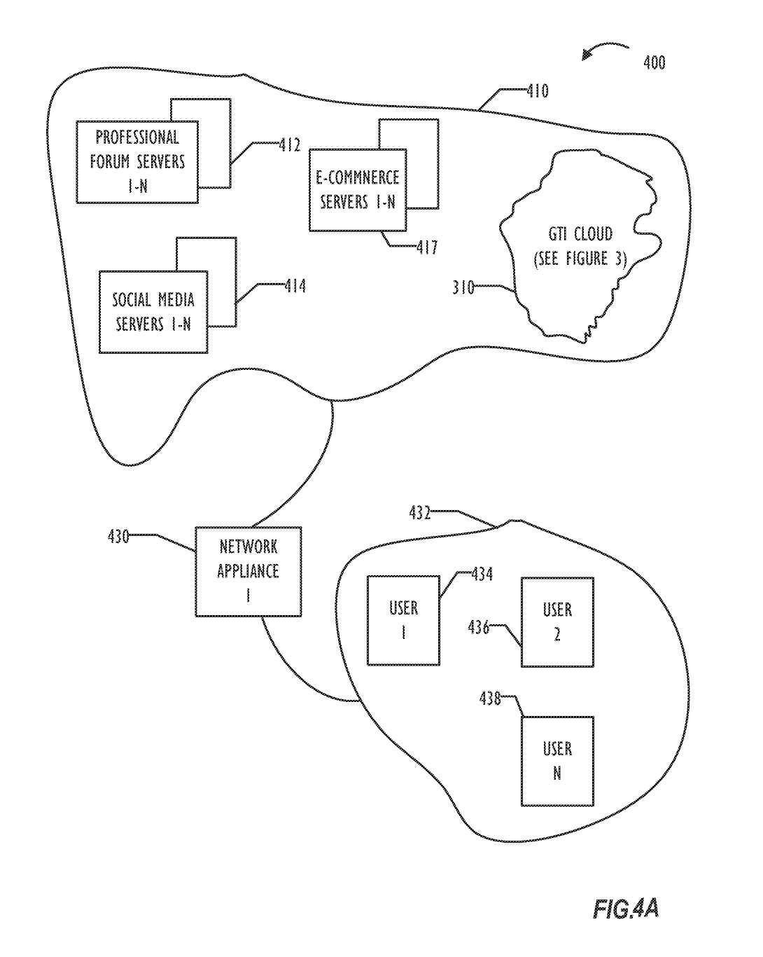

Referring now to FIG. 3, a block diagram 300 illustrates one example of a global threat intelligence (GTI) cloud 310. A GTI cloud 310 can provide a centralized function for a plurality of clients (sometimes called subscribers) without requiring clients of the cloud to understand the complexities of cloud resources or provide support for cloud resources. Internal to GTI cloud 310, there are typically a plurality of servers (e.g., Server 1 320 and Server 2 340). Each of the servers is, in turn, typically connected to a dedicated data store (e.g., 330 and 350) and possibly a centralized data store, such as Centralized Reputation DB 360. Each communication path is typically a network or direct connection as represented by communication paths 361, 362 and 370. Although diagram 300 illustrates two servers and a single centralized reputation database 360, a comparable implementation may take the form of numerous servers with or without individual databases, a hierarchy of databases forming a logical centralized reputation database, or a combination of both. Furthermore, a plurality of communication paths and types of communication paths (e.g., wired network, wireless network, direct cable, switched cable, etc.) could exist between each component in GTI cloud 310. Such variations are known to those of skill in the art and, therefore, are not discussed further here. Also, although disclosed herein as a cloud resource, the essence of functions of GTI cloud 310 could be performed, in an alternate embodiment, by conventionally configured (i.e., not cloud configured) resources internal to an organization. In the context of this disclosure, GTI cloud 310 provides an example of where a network appliance configured according to disclosed embodiments might obtain additional reputation information for use in determining a trust level to associate with a network flow.

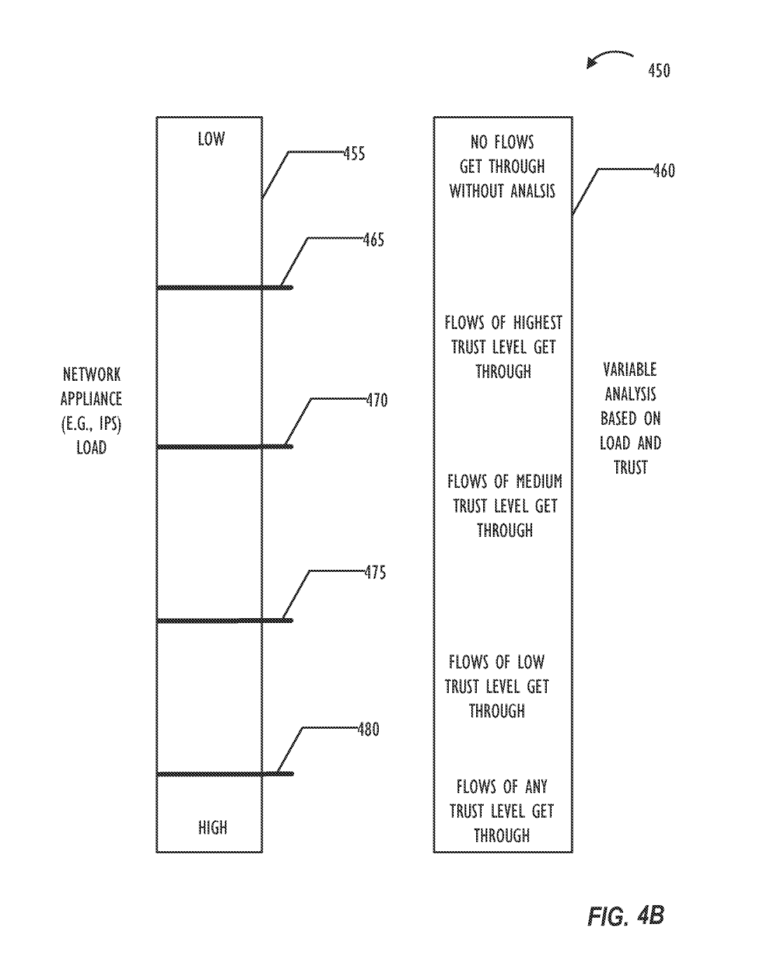

Referring now to FIGS. 4A-B, block diagram 400 of FIG. 4A illustrates a network (410) hosting one or more Application servers 1-N 412, 414 and 417 each providing a different type of service from an external network that could provide a network “flow” in the context of this disclosure. Of course, different types of network service providers are available from external networks and the concepts of this disclosure are not limited to the types of providers illustrated in FIG. 4A. In this example, network 410 could represent the Internet. Additionally in FIG. 4A are a plurality of users (e.g., 434, 436, and 438) on an internal network 432. Internal network 432 in this example is serviced by network appliance 430 which could be configured according to one or more disclosed embodiments. For example, user 1 (434) could request streaming video data from social media server 414. If the streaming video data from server 414 does not present itself (after analysis) as potentially malicious then the flow between server 414 and client 434 could become “trusted.” Once load on network appliance 430 crosses a first threshold further analysis (e.g., DPI) between server 414 and client 434 could be skipped so that analysis of flow traffic between any server in network 410 and any other client in network 432 could be analyzed at an appropriate detail by network appliance 430.

In some embodiments, network appliance 430 can request from GTI cloud 310 (or some other reputation server) information about the server (or client) providing/receiving the flow to determine a proper trust level for a given flow. As is known to those of ordinary skill in the art, reputation servers such as GTI cloud 310 maintain comprehensive information about the reputation of any given computer system they are monitoring. The comprehensive information provided by a reputation server is generally related to the type of data that a given computer system is providing (e.g., malicious or trustworthy).

FIG. 4B illustrates in diagram 450 that a sliding scale of trust level can be used in conjunction with different load thresholds of a network appliance (e.g., 430). Block 455 illustrates a scale from low load to high load with a set of thresholds (465, 470, 475 and 480). As shown in block 460, when load is below first threshold 465 all flows are analyzed by the network appliance. Once load crosses a first threshold 465 flows having a highest level of trust can be passed through network appliance 430 without extra analysis (such as DPI). Similarly, when load crosses a second threshold 470 flows of medium trust level are allowed through along with flows of high trust level. This process can continue for any number of thresholds and trust levels. Also, once load crosses a highest threshold (e.g., 480) then network appliance could be configured to allow flows of any trust level (may be risky) or block all flows that do not already have an associated trust level (safer). As load fluctuates between the defined thresholds network appliance 430 can adjust which flows receive which level of analysis.

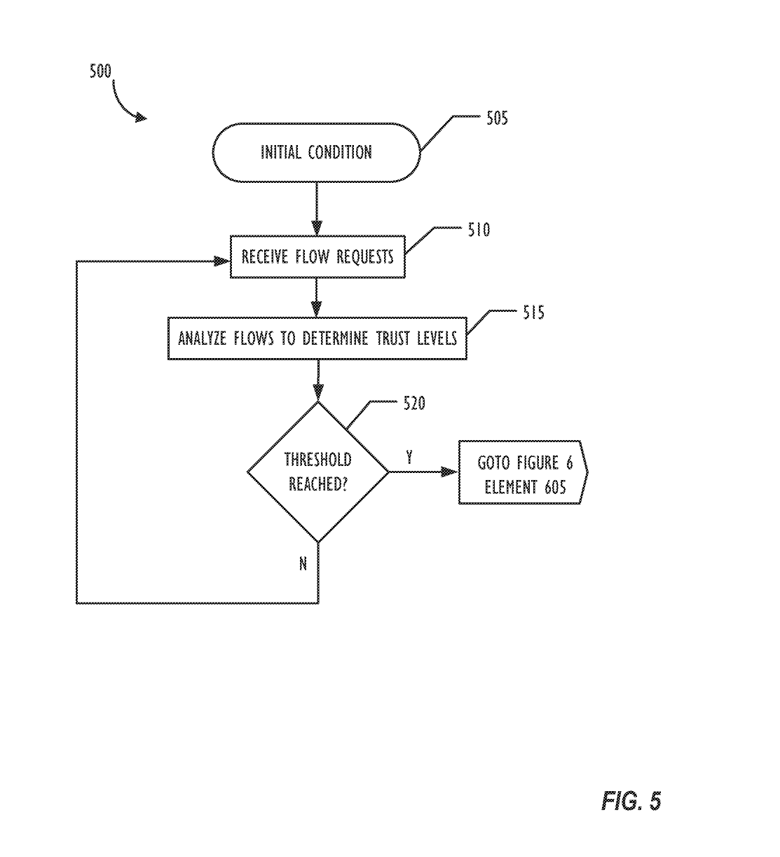

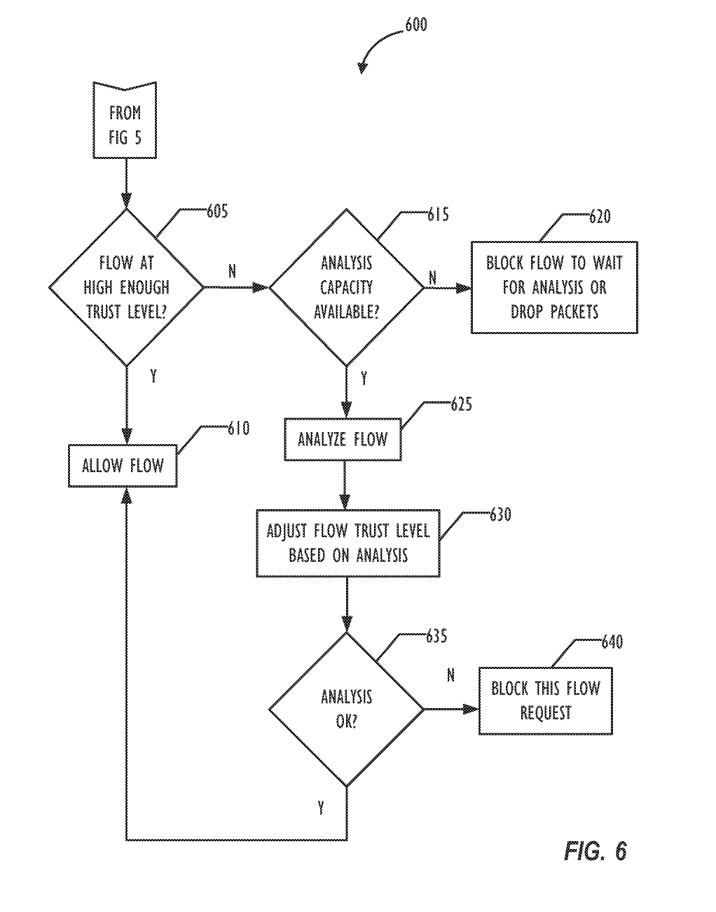

Referring now to FIG. 5 which illustrates flow chart of process 500 showing a possible initial operation of a network appliance such as network appliance 430. Beginning at an initial condition 505 load would be zero or close to zero. An initial set of network packets associated with a first flow could be received (block 510) and they would then be analyzed and associated with a trust level (described above). This process of analyzing all flows could be continued until a threshold is reached (block 520). Upon reaching a threshold process 500 could continue as shown in FIG. 6.

FIG. 6 illustrates process 600 which in some embodiments is a continuation of process 500. Beginning at block 605, a network appliance (e.g., 430) can determine if a flow is at a high enough trust level to pass through without further inspection. If so the flow is allowed (block 610). However, if not, process 600 continues to block 615 where the network appliance (e.g., 430) can determine if there is any available capacity to perform the required analysis. If not, process 600 continues to block 620 where the flow is blocked to wait for available analysis capacity or dropped because it cannot be analyzed. If there is analysis capacity, process 600 continues to block 625 where the flow is analyzed using capabilities of the network appliance (e.g., 430). At block 630 the analysis results can be used to adjust the trust level for the associated flow just analyzed. At block 635, if the analysis is satisfactory, the flow can be allowed (block 610) or if the analysis indicates that the data packets contain anything suspicious the flow can be blocked (block 640). In this manner, flows of a high enough trust level are allowed through without analysis when a load of a network appliance (e.g., 430) is above a related threshold (i.e., load thresholds related to trust levels).

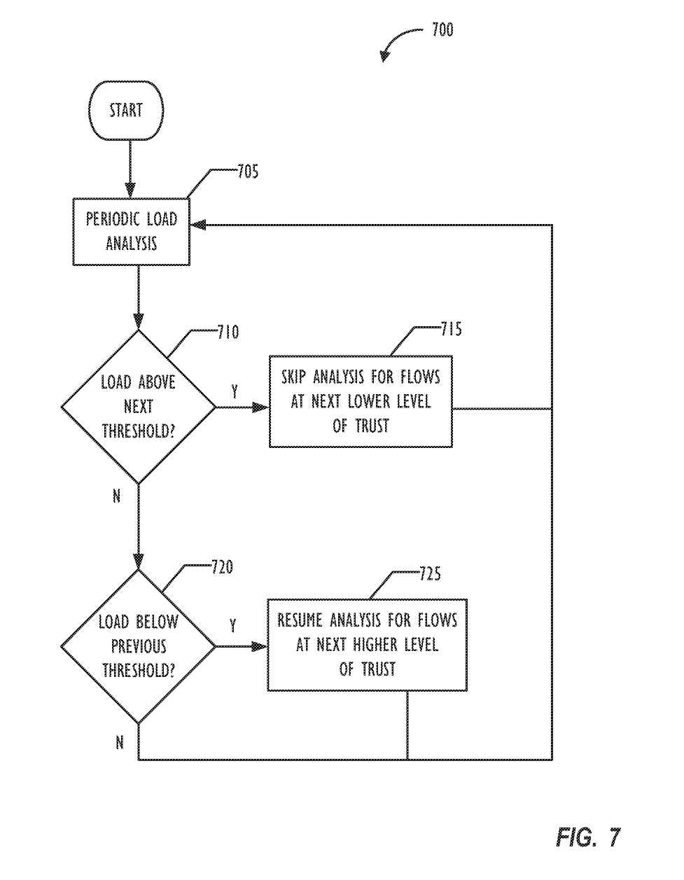

Referring now to FIG. 7, process 700 illustrates an example of adjusting which flows are analyzed based on an associated trust level. As described above with respect to FIG. 4B, flows of selected levels of trust can be associated with different load ranges. Beginning at block 705 an increased load threshold can be checked at block 710. If the load is higher than a next threshold, process 700 continues to block 715, where the processors of a network appliance (e.g., 430) can be configured to skip analysis for a next lower level of trust. Alternatively, if load is below a previous threshold (block 720) (because the load has reduced over time) then the network appliance can resume analysis of flows at a next higher level of trust (block 725). Also if load remains between two thresholds then process 700 illustrates that nothing is adjusted relative to the analysis performed.

### EXAMPLES

In a first example embodiment, a network device configured to perform analysis of network traffic comprises one or more processors, one or more network communication interfaces, and a memory communicatively coupled to the one or more processors. In this example, the memory stores instructions to cause the one or more processors to: receive network packets from the one or more communication interfaces, the network packets associated with a network flow; determine that current load of the network device is above a first pre-defined threshold; obtain an indication of a first trust level for the network flow; and allow the received network packets to proceed through the network device based upon a determination that current load and first flow trust level permit the received network packets to proceed without further analysis.

In the above example, the first trust level represents a high level of trust for the network flow. Also, the one or more processors could determine that current load of the network device has increased above a second pre-defined threshold; and allow network packets associated with a second trust level to proceed through the network device without further analysis in addition to allowing the network packets associated with the first trust level. As explained above, the first trust level can represent a high level of trust while the second trust level represents a medium level of trust. Further, the example network device could determine that current load of the network device has decreased below the second pre-defined threshold; and resume analysis of network packets associated with the second trust level prior to allowing the network packets to proceed through the network device. Additionally, the example network device could perform analysis of network packets associated with a trust level less trustworthy than the second trust level and the analysis of network packets could include deep packet inspection. The example network device could additionally include instructions to cause its one or more processors to obtain an indication of a first trust level comprise instructions to cause the one or more processors to query a reputation server for information pertaining to the network flow. The reputation server could be a reputation server configured to communicate with a plurality of different network devices and the plurality of different network devices could be in a plurality of different network domains.

Additionally, the example network device could determine that current load of the network device has decreased below the first pre-defined threshold; and resume analysis of network packets associated with the first trust level prior to allowing the network packets to proceed through the network device. As explained in the above examples, the network device could therefore control its load and processing of network flows as appropriate.

In a second example embodiment a non-transitory computer readable medium could be created with instructions stored thereon to cause one or more processors to: receive network packets associated with a network flow at a network device configured to perform network traffic analysis; determine that current load of the network device is above a first pre-defined threshold; obtain an indication of a first trust level for the network flow; and allow the received network packets to proceed through the network device based upon a determination that current load and first flow trust level permit the received network packets to proceed without further analysis. The first trust level could represent a high level of trust for the network flow.

The example readable medium could further comprise instructions stored thereon to cause one or more processors to: determine that current load of the network device has increased above a second pre-defined threshold; and allow network packets associated with a second trust level to proceed through the network device without further analysis in addition to allowing the network packets associated with the first trust level. In the above examples, the first trust level represents a high level of trust and the second trust level represents a medium level of trust.

Additionally, the example computer readable medium could further comprise instructions stored thereon to cause one or more processors to: determine that current load of the network device has decreased below the second pre-defined threshold; and resume analysis of network packets associated with the second trust level prior to allowing the network packets to proceed through the network device. The example computer readable medium could also further comprise instructions stored thereon to cause one or more processors to perform analysis of network packets associated with a trust level less trustworthy than the second trust level. The analysis of network packets could include deep packet inspection. The first trust level could be obtained and determined in part by a query to a reputation server for information pertaining to the network flow. The reputation server could be configured to communicate with a plurality of different network devices in a single network domain or in a plurality of different network domains. The example computer readable medium could also have instructions to cause one or more processors to: determine that current load of the network device has decreased below the first pre-defined threshold; and resume analysis of network packets associated with the first trust level prior to allowing the network packets to proceed through the network device.

In a third example a method of controlling load on a network device could include receiving network packets associated with a network flow at a network device configured to perform network traffic analysis; determining that current load of the network device is above a pre-defined threshold; obtaining an indication of a first trust level for the network flow; and allowing the received network packets to proceed through the device based upon a determination that current load and trust level permit the received network packets to proceed without further analysis. In this example method, the first trust level can represent a high level of trust for the network flow. The method can also include: determining that current load of the network device has increased above a second pre-defined threshold; and allowing network packets associated with a second trust level to proceed through the network device without further analysis in addition to allowing the network packets associated with the first trust level. The first trust level can represent a high level of trust while the second trust level represents a medium level of trust. The example method could also include determining that current load of the network device has decreased below the second pre-defined threshold; and resuming analysis of network packets associated with the second trust level prior to allowing the network packets to proceed through the network device. Also, the method could include performing analysis of network packets associated with a trust level less trustworthy than the second trust level. The method of the above examples could include a query to a reputation server for information about a reputation pertaining to the network flow to be used in determining a level of trust for different network flows.

Finally, the method could include determining that current load of the network device has decreased below the first pre-defined threshold; and resuming analysis of network packets associated with the first trust level prior to allowing the network packets to proceed through the network device.

In the foregoing description, for purposes of explanation, numerous specific details are set forth in order to provide a thorough understanding of the disclosed embodiments. It will be apparent, however, to one skilled in the art that the disclosed embodiments may be practiced without these specific details. In other instances, structure and devices are shown in block diagram form in order to avoid obscuring the disclosed embodiments. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one disclosed embodiment, and multiple references to “one embodiment” or “an embodiment” should not be understood as necessarily all referring to the same embodiment.

It is also to be understood that the above description is intended to be illustrative, and not restrictive. For example, above-described embodiments may be used in combination with each other and illustrative process acts may be performed in an order different than shown. Many other embodiments will be apparent to those of skill in the art upon reviewing the above description. The scope of the invention therefore should be determined with reference to the appended claims, along with the full scope of equivalents to which such claims are entitled. In the appended claims, terms “including” and “in which” are used as plain-English equivalents of the respective terms “comprising” and “wherein.”

What is claimed is:

1. A network device configured to perform analysis of network traffic, the network device comprising:
one or more processors;
one or more network communication interfaces; and
a memory communicatively coupled to the one or more processors, wherein the memory stores instructions to cause the one or more processors to:
receive network packets from the one or more communication interfaces, the network packets associated with a network flow;
determine that current load of the network device is above a first pre-defined threshold;
obtain an indication of a first trust level for the network flow; and
allow the received network packets to proceed through the network device based upon a determination that current load and first flow trust level permit the received network packets to proceed without further analysis.

2. The network device of claim 1, wherein the first trust level represents a high level of trust for the network flow.

3. The network device of claim 1, wherein the memory further stores instructions to cause the one or more processors to:
determine that current load of the network device has increased above a second pre-defined threshold; and
allow network packets associated with a second trust level to proceed through the network device without further analysis in addition to allowing the network packets associated with the first trust level.

4. The network device of claim 3, wherein the first trust level represents a high level of trust and the second trust level represents a medium level of trust.

5. The network device of claim 3, wherein the memory further stores instructions to cause the one or more processors to:
determine that current load of the network device has decreased below the second pre-defined threshold; and
resume analysis of network packets associated with the second trust level prior to allowing the network packets to proceed through the network device.

6. The network device of claim 3, wherein the memory further stores instructions to cause the one or more processors to perform analysis of network packets associated with a trust level less trustworthy than the second trust level.

7. The network device of claim 6, wherein analysis of network packets comprises deep packet inspection.

8. The network device of claim 1, wherein the instructions to cause the one or more processors to obtain an indication of a first trust level comprise instructions to cause the one or more processors to query a reputation server for information pertaining to the network flow.

9. The network device of claim 8, wherein the reputation server comprises a reputation server configured to communicate with a plurality of different network devices.

10. The network device of claim 9, wherein the plurality of different network devices are in a plurality of different network domains.

11. The network device of claim 1, wherein the memory further stores instructions to cause the one or more processors to:
determine that current load of the network device has decreased below the first pre-defined threshold; and
resume analysis of network packets associated with the first trust level prior to allowing the network packets to proceed through the network device.

12. A non-transitory computer readable medium comprising instructions stored thereon to cause one or more processors to:
receive network packets associated with a network flow at a network device configured to perform network traffic analysis;
determine that current load of the network device is above a first pre-defined threshold;
obtain an indication of a first trust level for the network flow; and
allow the received network packets to proceed through the network device based upon a determination that current load and first flow trust level permit the received network packets to proceed without further analysis.

13. The computer readable medium of claim 12, wherein the first us level represents a high level of trust for the network flow.

14. The computer readable medium of claim 12, further comprising instructions stored thereon to cause one or more processors to:
determine that current load of the network device has increased above a second pre-defined threshold; and
allow network packets associated with a second trust level to proceed through the network device without further analysis in addition to allowing the network packets associated with the first trust level.

15. The computer readable medium of claim 14, wherein the first trust level represents a high level of trust and the second trust level represents a medium level of trust.

16. The computer readable medium of claim 14, further comprising instructions stored thereon to cause one or more processors to:
determine that current load of the network device has decreased below the second pre-defined threshold; and
resume analysis of network packets associated with the second trust level prior to allowing the network packets to proceed through the network device.

17. The computer readable medium of claim 14, further comprising instructions stored thereon to cause one or more processors to perform analysis of network packets associated with a trust level less trustworthy than the second trust level.

18. The computer readable medium of claim 7, wherein analysis of network packets comprises deep packet inspection.

19. The computer readable medium of claim 12, wherein the instructions to cause the one or more processors to obtain an indication of a first trust level comprise instructions to cause the one or more processors to query a reputation server for information pertaining to the network flow.

20. The computer readable medium of claim 19, wherein the reputation server comprises a reputation server configured to communicate with a plurality of different network devices.

21. The computer readable medium of claim 20, wherein the plurality of different network devices are in a plurality of different network domains.

22. The computer readable medium of claim 12, further comprising instructions stored there on to cause one or more processors to:
determine that current load of the network device has decreased below the first pre-defined threshold; and
resume analysis of network packets associated with the first trust level prior to allowing the network packets to proceed through the network device.

23. A method, comprising:
receiving network packets associated with a network flow at a network device configured to perform network traffic analysis;
determining that current load of the network device is above a pre-defined threshold;
obtaining an indication of a first trust level for the network flow; and
allowing the received network packets to proceed through the device based upon a determination that current load and trust level permit the received network packets to proceed without further analysis.

24. The method of claim 23, wherein the first trust level represents a high level of trust for the network flow.

25. The method of claim 23, further comprising:
determining that current load of the network device has increased above a second pre-defined threshold; and
allowing network packets associated with a second trust level to proceed through the network device without further analysis in addition to allowing the network packets associated with the first trust level.
